(19) United States
(12) Patent Application Publication
(10) Pub. No.: US 2006/0204838 A1
(43) Pub. Date: Sep. 14, 2006

(54) Solar driven concentration cell

(76) Inventors: Michael A. Bobrik, Arlington, VA (US); Edwin Austreng, Stockbridge, MI (US)

Correspondence Address: Leander F. Aulisio, 320 23rd Street #705, Arlington, VA, 22202, US

(21) Appl. No.: 11/366,396

(22) Filed: Mar. 3, 2006

Related U.S. Application Data
(60) Provisional application No. 60/657,713, filed on Mar. 3, 2005.

(51) Int. Cl. H01M 8/20; H01M 2/04

(52) U.S. Cl. 429/105; 429/175

(57) ABSTRACT

The solar driven concentration cell comprising a cathode half-cell, an anode half-cell and a transparent covering or lid extending over both half-cells and sloping downwardly from the cathode half-cell to the anode half-cell, wherein heat from the sun causes solvent from the half-cells to evaporate and subsequently condense on an inside surface of the covering or lid and wherein condensed solvent is then pulled by gravity substantially into the anode half-cell, whereby a concentration gradient is maintained across the electrodes of the cell to extend the useful life of the concentration cell.

### BACKGROUND OF THE INVENTION

1. Field of the Invention

The present invention relates generally to galvanic electrochemical cells of the type known as concentration cells, and more particularly to a solar driven concentration cell which uses thermal energy generated by the sun to drive the cell in order to maintain a high voltage output by maintaining a high electrolyte concentration gradient across the cell.

2. Description of the Related Art

A concentration cell is a well-known source of electrochemical energy. The concentration cell typically comprises a cathode half-cell including a first electrolyte and an electrode, and an anode half-cell including a second electrolyte and an electrode, the two half-cells being connected by a salt bridge, selective ion-exchange membrane, or other ion-exchange element which isolates the two electrolyte solutions and electrodes while permitting the exchange of ions between the two half-cells. In the cathode half-cell, cations in the electrolyte are reduced at the interface between the electrolyte and the electrode. The metal formed by reduction of the cations plates the electrode. In the anode half-cell the electrode is oxidized and releases cations into the electrolyte, the electrode being consumed in the process. Each half-cell produces a voltage which may be expressed in relation to a standard hydrogen electrode by the Nernst equation as:
E=E⁰−0.0592/nlog[C]^{c}[D]^{d}/[A]^{a}[B]^{b} (1)
at 25° C. for the half-reaction aA+bB [symbol] cC+dD. In this equation E⁰ represents the standard electrode potential for the half-reaction and n represents the number of moles of electrons involved in the half-reaction. Strictly speaking, the quantities in brackets represent activities, but in practice molar concentrations are used for most calculations.

The voltage for the cell as a whole may be calculated from:
E_{cell}=E_{cathode}−E_{anode} (2)
and if the voltage for the cell is positive, the cell is galvanic and stores energy, while if the cell voltage is negative the cell is electrolytic and requires an external source of electrical energy for operation. If the material used for the electrodes is the same and the electrolyte is the same, equations (1) and (2) can be combined to produce:
E_{cell}=−0.0592/nlog[low]_{anode}/[high]_{cathode} (3)
from which it is apparent that the cell produces no voltage when the concentration of the electrolyte in the anode half-cell is equal to the concentration of the electrolyte in the cathode half-cell. Consequently, a galvanic electrochemical cell requires that the electrolyte concentration in the anode half-cell be less than the concentration of the electrolyte in the cathode half-cell.

The concentration cell typically produces a small voltage, in the order of a few millivolts or hundreds of millivolts. Concentration cells may be combined in series to produce a larger voltage for serving as a power source for driving a load requiring a voltage higher than that produced by a single concentration cell. Concentration cells are useful as a cheap way of producing a small voltage for a short time. When the material used for the two electrodes is the same and the electrolyte used in the two half-cells is the same, differing only in concentration, the concentration cell has the additional advantage that no material is lost, since the metal consumed from the anode electrode is deposited on the cathode electrode. The foregoing description of the concentration cell is well-known in the art.

A problem with using the concentration cell as a source of electrical power is that the voltage produced by the concentration cell, which depends upon the ratio of the electrolyte concentration in the two half-cells (referred to as the concentration gradient), does not remain constant. Rather, when a load is placed across the electrodes or the electrodes are shorted together by a conductor, the cell strives to obtain equilibrium; and the concentration of cations in the cathode half-cell decreases while the concentration of cations in the anode half-cells increases until the two concentrations become equal. Consequently, the voltage produced by the concentration cell steadily decreases until the cell potential becomes zero. If a way can be found to maintain a concentration gradient across the cell, then it becomes more feasible to provide a long term economical source of electrical power with a low cost in materials, since there is no net consumption of materials.

Some efforts have been made to address this problem. U.S. Pat. No. 4,292,378 issued on Sep. 29, 1981, to Michael Krumpelt, et al., describes a concentration cell with the two half-cells separated by an ion-exchange member. The electrodes are aluminum and the half-cells contain the same electrolyte-solvent combination in different concentrations. The electrolyte is preferably aluminum chloride (AlCl₃) and the solvent is non-aqueous, preferably ethyl pyridinium chloride, although the salt of an alkali metal may be used. When the concentration gradient of aluminum ions across the two half-cells falls below a predetermined level, the electrolyte solutions are transported from the cell compartments to a distillation column which is operated below 400° C. so that it may be fueled by a solar collector or by industrial waste gases. The higher boiling point solvent is drained from the bottom portion of the column by a pump to a reservoir and eventually returned to the anode half-cell by another pump to dilute the solution and lower the electrolyte concentration. The lower boiling point AlCl₃ electrolyte is removed from the upper portion of the column and pumped to a second reservoir and eventually returned to the cathode half-cell by another pump to raise the aluminum ion concentration in that half-cell. The apparatus in Krumpelt is not adapted for use with electrolytes in aqueous solution, requires expensive external components including pumps and a distillation column, requires a sensor or some form of monitoring before instituting measures to provide for correcting the concentration gradient, and requires temperatures up to 400° C. to operate, rendering the device less suitable for residential or consumer use.

U.S. Pat. No. 4,410,606 issued on Oct. 18, 1983, to Raouf O. Loutfy et al. describes a low temperature and thermally regenerative electrochemical system comprising an electrochemical cell having one half-cell containing an aqueous copper (II) sulfate (CuSO₄) solution having two redox couples and a complexing agent, such as acetonitrile, which shifts the redox couple based on the concentration of the complexing agent, and separated by an ion-exchange membrane from a CuSO₄ solution of lower concentration and a source of copper metal in the other half-cell. As the copper ion concentration is decreased in the first cell, a portion of the electrolyte solution is drawn off to a distillation column where the lower boiling point acetonitrile is drawn off for return to the second half-cell, switching the redox couple in the first cell so that copper ion is regenerated.

U.S. Pat. No. 4,037,029 issued on Jul. 19, 1977, to John H. Anderson describes a photoelectrogenerative cell with three different variations. In a first embodiment the two half-cells have an electrolyte of equal concentration separated by a membrane permitting ion-exchange, the anolyte half-cell also containing a photosensitive material such as cadmium sulfide, and being irradiated with light. In a second embodiment, the cell comprises a diaphragm separating two half-cells containing equal concentrations of a photochemical electrolyte, such a cuprous chloride, CuCl, the anode being irradiated by light and the cathode being shielded, the electrolyte solutions being protected from oxidation by an oil film. The third embodiment uses photosynthesis to develop a potential difference. The Anderson device differs from the present invention in teaching the use of electrolyte solutions of equal concentration, in the use of a photochemical electrolyte to generate a potential, and in the teaching of an oil film to prevent evaporation and oxidation of the electrolyte. The Anderson device does not address the problem of maintaining a concentration gradient in a concentration cell.

Other devices which illustrate sources of electrical power which utilize some form of energy derived from the sun include U.S. Pat. No. 3,031,520, issued Apr. 24, 1962 to Clampitt, et al. (cell using photochemical reaction of organic isomers); U.S. Pat. No. 3,925,212, issued Dec. 9, 1975 to D. l. Tchernev (cell producing electricity by photovoltaic semiconductor devices which decompose water); U.S. Pat. No. 4,262,066, issued Apr. 14, 1981 to Brenneman, et al. (cell which generates electricity using photoreactive organic dye which is regenerated); and U.S. Pat. No. 4,522,695, issued Jun. 11, 1985 to C. W. Neefe (device for generating hydrogen fuel which uses photovoltaic semiconductor material disposed in foam on transparent, sloped roof).

None of the above inventions and patents, taken alone or in combination, is seen to describe the instant invention as claimed.

### SUMMARY OF THE INVENTION

The solar driven concentration cell has a housing with a first chamber for a cathode half-cell and a second chamber for an anode half-cell. The cathode half-cell contains a metal electrode and an electrolyte solution having a concentration of cations of the same metal as the electrode. The anode half-cell contains a metal electrode and an electrolyte solution having a concentration of cations of the same metal as the electrode. The cathode electrode and the anode electrode are made of the same metal. The electrolyte in the cathode and anode half-cells is the same, except that the cathode electrolyte solution has a higher concentration of electrolyte than. the anode electrolyte solution. The two chambers are connected by an ion-exchange member, and can include a semipermeable barrier, which permits the flow of ions between the two half-cells. The housing has a transparent lid to admit sunlight and seal the cell so that the solvent does not evaporate to the atmosphere, the lid extending over both chambers and sloping downward from the cathode half-cell to the anode half-cell side of the housing. Upon exposure to the sun, solvent evaporates and condenses on the cathode side of the lid, rolls down the lid until it is above the anode half-cell, and drops into the anode half-cell to maintain the concentration gradient across the cell, thereby extending the life of the cell. A method for solar driving a concentration cell includes the steps of selectively evaporating solvent from the cathode half-cell and transferring the condensed solvent to the anode half-cell in order to automatically maintain a concentration gradient across the cell.

Accordingly, it is a principal object of the invention to provide a solar driven distillation apparatus coupled with a concentration cell in order to maintain a concentration gradient across the cell, thereby maintaining the voltage potential produced by the cell.

It is another object of the invention to provide a solar driven concentration cell for producing electricity which maintains the voltage produced by the cell through geometric construction of the housing in combination with thermal energy derived from the sun, rather than external pumps and distillation columns.

It is a further object of the invention to provide a solar driven concentration cell producing a voltage for an extended time without net consumption of any materials in an economically feasible manner.

Still another object of the invention is to provide a heat driven concentration cell which economically distills aqueous electrolyte solvent and redistributes the solvent between the half-cells automatically to maintain electrical output voltage for extended periods of time, even in the dark.

It is an object of the invention to provide improved elements and arrangements thereof in an apparatus for the purposes described which is inexpensive, dependable and fully effective in accomplishing its intended purpose.

These and other objects of the present invention will become readily apparent to those of ordinary skill in the art upon further review of the following specifications and drawings.

### BRIEF DESCRIPTION OF THE DRAWINGS

The accompanying drawings, in conjunction with the general description given above, and the detailed description of the preferred embodiments given below, serve to illustrate and explain the principles of the preferred embodiments of the best mode of the invention presently contemplated, wherein:

FIG. 1 is a perspective view of a first embodiment of a solar driven concentration cell according to the present invention.

FIG. 2 is an elevational view of the embodiment of the solar driven concentration cell of FIG. 1.

FIG. 3 is an elevational view of a second embodiment of a solar driven concentration cell according to the present invention.

FIG. 4. is a sectional view along the line 4-4 of FIG. 3

FIG. 5. is a sectional view along the line of 5-5 of FIG. 3.

Similar reference characters denote corresponding features consistently throughout the attached drawings.

### DETAILED DESCRIPTION OF THE INVENTION

In the following detailed description of the invention, reference is made to the accompanying drawings which form a part of the disclosure, and, in which are shown by way of illustration, and not of limitation, specific embodiments by which the invention may be practiced. In the drawings, like numerals describe substantially similar components throughout the several views. The embodiments illustrated are described in sufficient detail to enable those skilled in the art to practice the invention. Other embodiments may be utilized and derived therefrom, such that structural and logical substitutions and changes may be made without departing from the scope of the invention. The following detailed description, therefore, is not to be taken in a limiting sense, and the scope of the invention is defined only by the appended claims, along with the full range of equivalents to which such claims are entitled.

The present invention is directed to a galvanic heat or solar driven concentration cell useful for producing electricity economically.

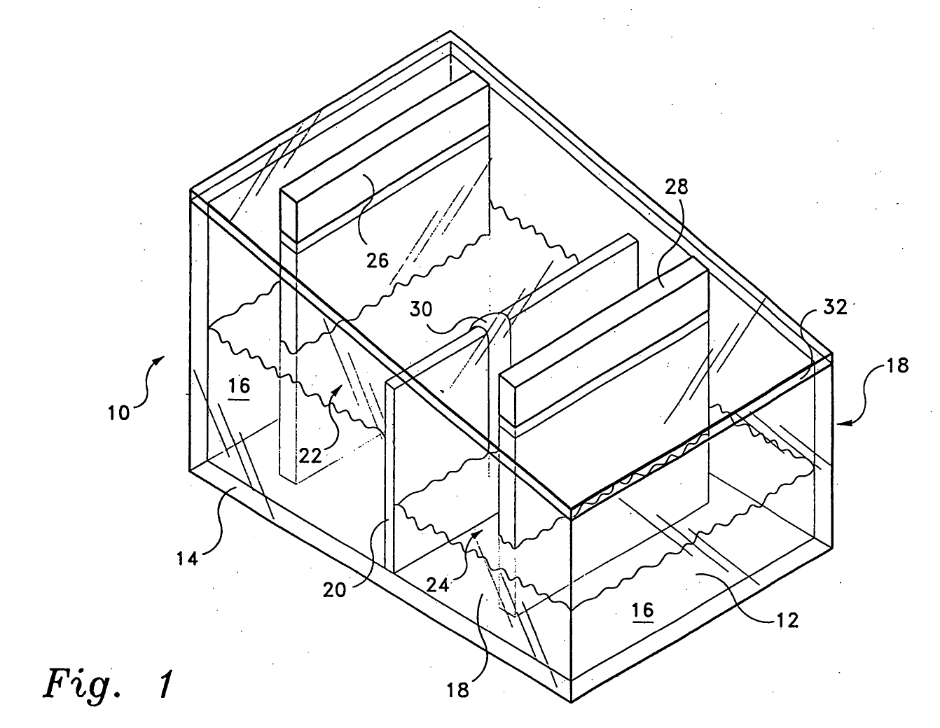

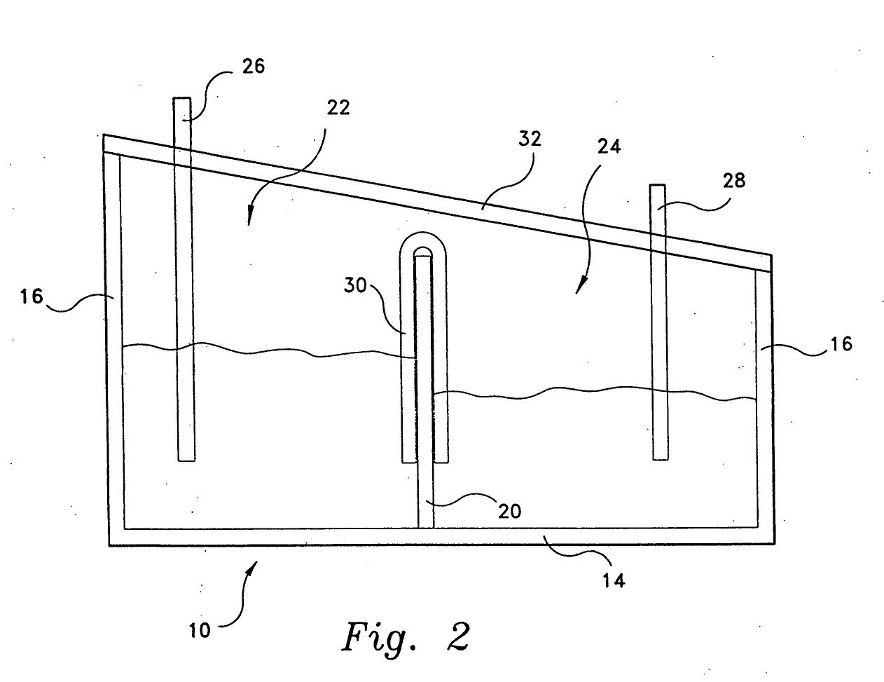

A first embodiment of the concentration cell 10 is shown in FIGS. 1 and 2. In this embodiment the concentration cell 10 is contained within a box-shaped housing or enclosure 12 defined by bottom wall 14, two opposing end walls 16, and two opposing side walls 18. A partition wall 20 divides the housing into a cathode chamber 22 (also referred to as the “cathode half-cell”) and an anode chamber 24 (also referred to as the “anode half-cell”). The cathode chamber 22 holds a quantity of a first electrolyte solution and has a first metal electrode 26 extending into the electrolyte solution. The. anode chamber 24 holds a second electrolyte solution and has a second metal electrode 28 extending into the second electrolyte solution. The partition wall 20 physically separates the first and second electrolyte solutions so that there is no mixing or commingling of the two electrolyte solutions. In a concentration cell 10 according to the present invention, the two metal electrodes 26 and 28 are preferably made from the same metal, e.g., copper, silver, nickel, or other conductive metals. The first electrolyte solution and the second electrolyte solution each contain cations of the same metal as the electrodes 26 and 28. For example, if the electrodes 26 and 28 are made from copper metal, then the electrolyte solutions may be aqueous solutions of copper salts, e.g., copper chloride dihydrate, copper sulfate, copper nitrate, or other water soluble copper salts, preferably copper (II) salts.

The first and second electrolyte solutions are in communication with each other through an ion-exchange member. In FIGS. 1 and 2, the ion-exchange member is shown as a salt bridge in the form of a U-tube 30 which is inverted and placed over the partition wall 20, so that one end is below the surface of the first electrolyte solution in the cathode chamber 22 and the other end is below the surface of the second electrolyte solution in the anode chamber 24. Other salt bridges are contemplated, e.g., ceramic containers. The U-tube 30 is plugged at both ends and filled with an electrolyte which is impregnated with the solvent, e.g., sodium chloride impregnated with water, so that positive charges may flow to the cathode 22 and negative charges may flow to the anode 24. It will be understood that although the ion-exchange member is shown as a U-tube in the drawings, the ion-exchange member may be a straight tube passing through the partition wall 20, or the partition wall 20 may be formed from a porous ion-selective membrane, or any other form of ion-exchange member for use with a concentration cell.

A voltmeter (not shown) may be connected to the electrodes 26 and 28. Alternatively, a resistive load (not shown) to be powered by the concentration cell 10 may be connected across the electrodes 26 and 28, or the electrodes 26 and 28 may be shorted together by a length of electrically conductive wire to produce a charging current. The cathode electrode 26 of a first concentration cell 10 may be electrically connected to the anode electrode 28 of a second concentration cell 10 in order to connect a plurality of concentration cells in series, thereby increasing the voltage output.

In order to produce a voltage, the concentrations of the electrolyte solutions in the cathode half-cell 22 and the anode half-cell 24 must be different. Typically, the cathode half-cell 22 has a greater electrolyte concentration than the anode half-cell 24. For example, if the electrodes 26 and 28 are copper and the electrolyte solution is an aqueous solution of copper (II) sulfate, concentration cell 10 is set up with the initial concentration of copper (II) sulfate in the cathode half-cell 22 being greater than the concentration of copper (II) sulfate in the anode half-cell 24. The ratio of the concentrations may be, for example, on the order of four degrees of magnitude (10,000:1). The copper ions in the cathode half-cell 22 are reduced to metallic copper and deposited on the cathode electrode 26. On the other hand, copper from the anode electrode 28 is oxidized to copper ion that is released into the second electrolyte solution in the anode half-cell 24. There is no net change in the quantity of copper metal in the cell 10 as a whole, since the copper metal deposited on the electrode 26 is removed from the electrode 28, and there is no net change in the concentration of the copper ion in the concentration cell 10 as a whole, since the quantity of copper ion reduced in the cathode half-cell 22 if offset by the quantity of copper ions produced in the anode half-cell by oxidation of the electrode 28. However, the effect of the reactions in the two half-cells 22 and 24 tends to equalize the concentration of copper ions in the two half-cells, reducing the voltage output. The copper ion concentration in the cathode half-cell 22 becomes more dilute due to the plating of copper metal on the electrode 26, while the concentration of copper ions becomes greater in the anode half-cell 24 due to oxidation of the electrode 28.

In order to maintain a concentration gradient across the two half-cells 22 and 24, the concentration cell 10 of the present invention is furnished with a transparent lid 32 placed over the opening of the housing 12 defined by the end walls 16 and side walls 18. The lid 32 prevents solvent from escaping to the atmosphere from the concentration cell 10. A seal may be interposed between the lid 32 and the top edges of the walls 16 and 18 to ensure a watertight and airtight seal. Moreover, the lid slopes downward from the cathode half-cell 22 to the anode half-cell 24, the end wall 16 in the cathode half-cell 22 being taller than the end wall 16 of the anode half-cell 24 side of the housing 12. The height of the partition wall 20 is less than the height of the side walls 18 at the point where the partition wall 20 is joined to the side walls 18, leaving a gap between the partition wall 20 and the lid 32.

Since the lid 32 is made from a clear or transparent material (glass, polycarbonate, acrylic resin, or other synthetic plastic), the chambers 22 and 24 absorb heat when exposed to the sun and the electrolyte solutions in the two half-cells evaporate and then condense on the bottom surface of the lid 32. Because of the slope of the lid 32, water condensing on the lid 32 above the anode half-cell 24 will fall back into the anode chamber 24, while water condensing on the lid 32 above the cathode half-cell 22 tends to roll down the lid 32 until it is above the anode half-cell 24, where it drops into solution. This distilling of the electrolyte solutions concentrates the first electrolyte solution in the cathode half-cell 22 and dilutes the second electrolyte solution in the anode half-cell 24, thereby maintaining a concentration gradient across the concentration cell 10.

Although the end walls 16 and side walls 18 of the housing 12 are shown as being transparent in FIGS. 1 and 2, it is possible to improve the efficiency of the concentration cell 10 by adjusting the color of the walls 16 and 18 of the half-cells 22 and 24. For example, the walls 16 and 18 of the cathode half-cell 22 maybe made from a black material or from a transparent material with its surfaces painted black. The black walls have a tendency to absorb more heat from the sun and retain the heat over a longer period of time, resulting in an increased temperature gradient across the cell 10 and a greater rate of evaporation in the cathode half-cell 22 than the anode half-cell 24, with consequent increase in water transfer efficiency. Also, the walls 16 and 18 of the anode half-cell 24 may be covered by aluminum foil or made from a white material or from a transparent material which has been painted white in order to reflect the sun, keeping the anode half-cell 24 cooler than the cathode half-cell 22, the temperature gradient again leading to more efficient water transfer.

By maintaining the concentration gradient across the concentration cell, the voltage potential across the electrodes 26 and 28 is maintained for a longer period of time, even after the sun has set.

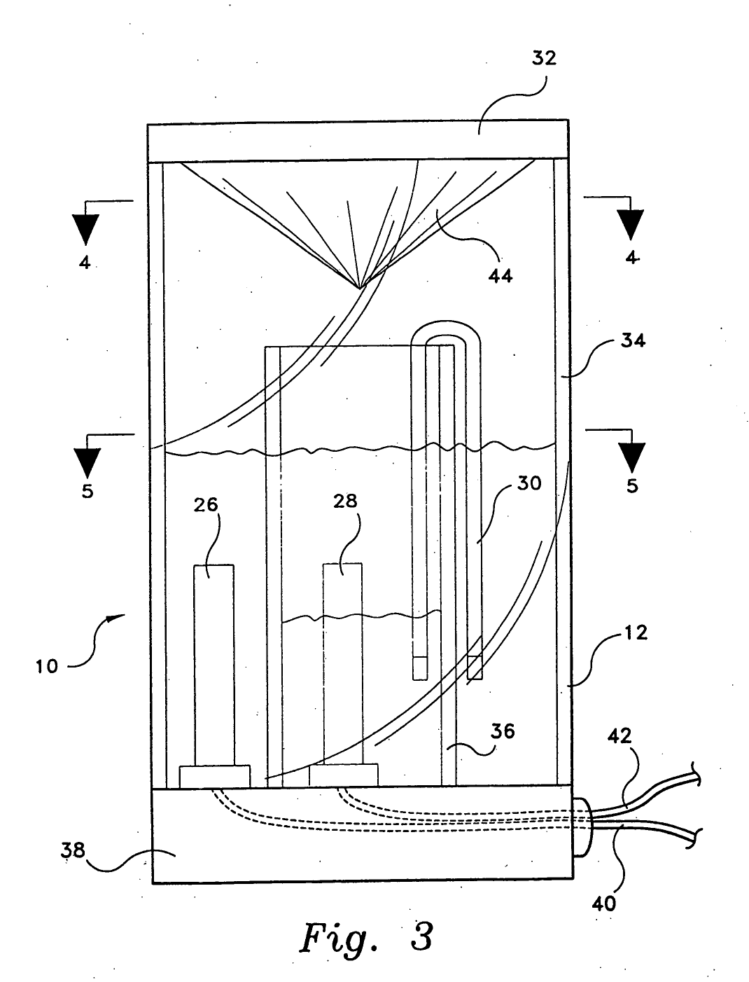

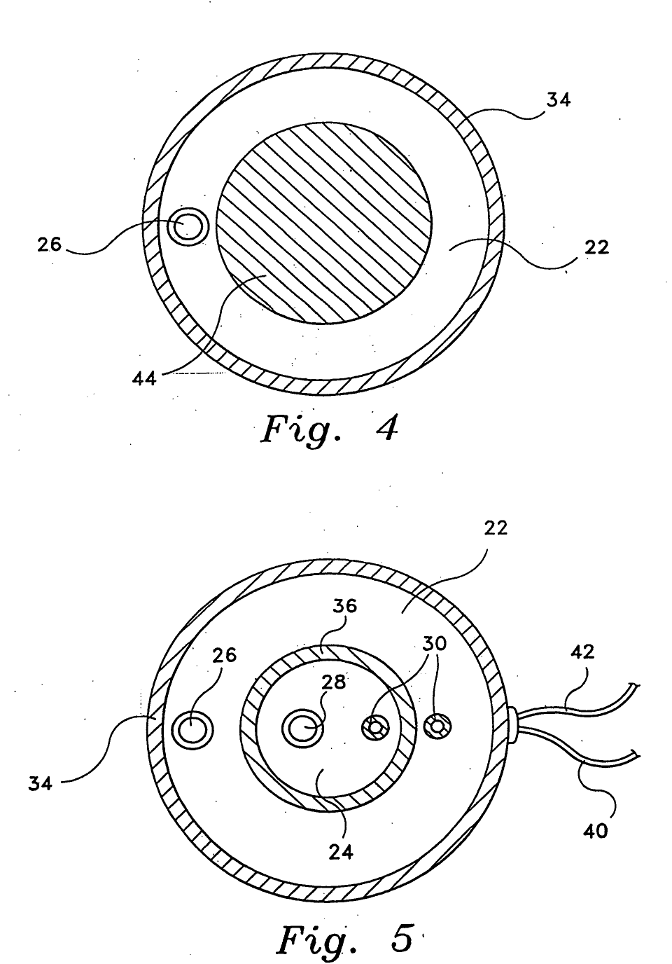

FIGS. 3 to 5 show an alternative embodiment of a concentration cell 10 according to the present invention. In this embodiment, the housing 12 comprises a pair of concentric cylinders 34 and 36 mounted on a base 38. The outer cylinder 34 has a greater diameter than the inner cylinder 36, the anode chamber 24 being defined by the wall of the inner cylinder 36, and the base 38 and the cathode half-cell 22 being defined by the annular space between the inner cylinder 36 and the outer cylinder 34 in combination with the base 38. An inverted U-tube 30 is positioned over a wall of the inner cylinder 36 as in the first embodiment. The U-tube 30 is plugged at both ends and filled with an electrolyte which is impregnated with the solvent. In this example, the cathode electrode 26 and the anode electrode 28 are shown as rods, although it will be understood that the electrodes 26 and 28 may have any desired shape, e.g., circular plates. The electrodes 26 and 28 may be attached to a terminal connected to wires 40 and 42, respectively, housed in the base 38 and exiting the base 38 through a grommet for attachment to a voltmeter, electrical load, etc.

In this embodiment, the concentration cell 10 has a circular lid 32 with an inverted cone 44 depending from the bottom surface of the lid 32 to maintain the concentration gradient. When the concentration cell 10 is placed in the sun, the cathode half-cell 22, as the exterior annular chamber, absorbs more heat than the anode half-cell 24. The first electrolyte solution evaporates and condenses on the bottom surface of the lid 32, rolls down the inverted cone 44 toward the apex of the cone 44, which is centered over the anode half-cell 24, and falls into the anode half-cell 24 by gravity.

Although the concentration cell 10 according to the present invention has been illustrated with two half-cells 22 and 24 disposed in the same housing 12, it will be understood by those skilled in the art that the half-cells 22 and 24 need not be disposed in the same housing 12. The teaching of the present invention extends to any concentration cell 10 in which the half-cells are connected by an ion-exchange member and in which a concentration gradient is maintained across the cell by distillation of the electrolyte solvent and passive transport of the solvent from the cathode half-cell 22 to the anode half-cell 24 by gravity. Further, although the electrolytic solutions have been described as being aqueous, other volatile non-aqueous solvents may be used. It is particularly contemplated that a concentration cell 10 may be made according to the principles of the present invention with a cathode half-cell 22 disposed on the exterior of a building or other structure for exposure to the sun, and an anode half-cell 24 disposed on the cooler interior of the building. Conversely, the cathode could be positioned in a warm building interior, while the anode would be in a very cold exterior, the solvent for the electrolyte being a low freezing point solvent.

It is evident that continued evaporation of the solvent in the cathode half-cell 22 and transport of the evaporated solvent to the anode half-cell 24 would eventually lead to no solvent at all in the cathode half-cell 22. This problem may be remedied by the addition of fresh solvent to the cathode half-cell 22. A further problem is that transport of solvent to the anode half-cell 24 may eventually lead to the solvent level in the anode half-cell 24 exceeding the height of the partitioned wall 20. At this juncture, the electrolyte solutions may be replaced with fresh solutions of known concentration. A semipermeable membrane could also maintain liquid levels. Yet another problem is that eventually the anode electrode 28 will be corroded by continued loss of metal by oxidation. This problem may be solved by reversing the position of the electrodes 26 and 28 in the concentration cell 10 to regenerate the anode electrode 28.

The present invention employs the use of heat, not light, to maintain a concentration gradient across the cathode and anode of a solar driven concentration cell. This results in the preservation of voltage potential. The concentration gradient is maintained by passive transport of liquid from the cathode chamber to the anode chamber.

The present invention relates to an improvement in a solar driven concentration cell. The improvement comprises the addition of a transparent covering or lid which has a geometric structure which allows for condensed liquid to flow substantially into the anode chamber. The transparent covering or lid can be in the shape of a slanted roof wherein the higher part of the roof is placed over the cathode chamber and the lower part of the roof is placed over the anode chamber. Any other geometric shape can be employed which produces the same results. The transparent covering or lid is engaged with a housing defining the cathode chamber and the anode chamber. The covering or lid, which along with a sealing member, makes the housing watertight, allows heat from the sun to vaporize the water contained in the two chambers. The vaporized water then contacts the interior surface of the lid, where it condenses and is pulled by gravity substantially into the anode chamber.

Since the electrodes are made of the same metal, none of the original materials are lost even after continuous operation of the concentration cell for long periods of time. And, even when the cell is spent, it can be rejuvenated simply by reversing the electrodes and adding water (or other suitable solvent) to the appropriate half-cell.

A method of solar driving a concentration cell for the production of electricity may be stated as comprising the following steps: (a) providing a concentration cell housing having a cathode half-cell and an anode half-cell connected by a salt bridge; (b) inserting a cathode electrode in the cathode half-cell and an anode electrode in the anode half-cell, the cathode and anode electrodes being made from the same metal; (c) preparing a first electrolyte solution and a second electrolyte solution using the same solvent and the same electrolyte, the electrolyte producing a cation of the same metal as said cathode and anode electrodes, the first electrolyte solution having a greater concentration of the metal cation than the second electrolyte solution; (d) placing a quantity of the first electrolyte solution in the cathode half-cell; (e) placing a quantity of the second electrolyte solution in the anode half-cell; (f) preventing escape of electrolyte solution from said concentration cell by placing a transparent, watertight lid over said cathode half-cell and said anode half-cell; (g) electrically connecting said cathode electrode to said anode electrode; (h) exposing said concentration cell to solar or heat (infrared) radiation in order to evaporate solvent from said first and second electrolyte solutions; (i) condensing the evaporated solvent; and (j) passively transporting the solvent evaporated from said cathode half-cell to said anode half-cell in order to maintain a concentration gradient across said concentration cell. The method may further comprise the steps of: selectively evaporating solvent from said cathode half-cell; furnishing the cathode half-cell with walls having a color which absorbs solar radiation; or furnishing the anode half-cell with walls having a color which reflects solar radiation. The steps of passively transporting solvent to the anode half-cell may further comprise sloping said lid downward from said cathode half-cell to said anode half-cell.

The following examples are included to explain the invention more fully and are in no way intended to limit the scope of the claims.

### EXAMPLE 1

A fully sealed concentration cell was constructed of transparent polycarbonate plastic material. The cell was divided to form two half-cells. A slanted roof, having the higher side covering the cathode half-cell and the lower side covering the anode half-cell, was constructed of transparent polycarbonate plastic material. Into each half-cell was placed a copper electrode and an aqueous solution of copper (II) chloride dihydrate, with the electrode partially submerged in the aqueous solution. The cathode half-cell contained a 1.0 M aqueous solution of copper (II) chloride dihydrate; and the anode half-cell contained a 0.0001 M aqueous solution of copper (II) chloride dihydrate. The two half-cells were connected with a salt bridge, in this example the salt bridge being a paper towel wetted with the aqueous solution of copper (II) chloride dihydrate

The internal resistance of the concentration cell was 60,000 ohms, and the initial voltage was 0.15 Volts. The cell was placed in sunlight. After an hour, the cell voltage as measured by a voltmeter was 0.11 Volts. The expected drop in voltage results from current drawn by the voltmeter and diffusion through the salt bridge.

### EXAMPLE 2

Two fully sealed concentration cells were constructed of transparent polycarbonate plastic material. The structural geometry of the cells was similar to that of the cell in Example 1, i.e., two half-cells with a slanted roof. The salt bridge for each cell was a U-shaped glass tube packed with unwoven cotton which was soaked in an aqueous solution of sodium chloride. The anode half-cell contained a copper electrode partially submerged in an aqueous solution of copper (II) sulfate (0.001 M). The cathode half-cell contained a copper electrode partially submerged in an aqueous solution of copper (II) sulfate (0.003 M). Each solution contained about 10 mL of vinegar to lower the pH and thus prevent precipitation of copper hydroxide.

One of the two concentration cells was painted black on the sides of the cathode compartment. Both cells were then placed in sunlight. Change in voltage over time was then measured for each cell. The following chart records the results.

| | Time (hours) | | | |
|---|---|---|---|---|
| | 0 | 1.5 | 4.0 | 6.5 |
| Voltage (mV) Black cell | 40 | 45 | 39 | 31 |
| Voltage (mV) Clear cell | 42 | 32 | 29 | 20 |

The concentration cell having the anode with sides painted black was able to better maintain the voltage over time. This is due to a larger temperature gradient which allows for more efficient exchange of water between the half-cells.

### EXAMPLE 3

A fully sealed concentration cell was constructed of transparent polycarbonate material. The cell was divided to form two half-cells. A slanted roof, having the higher side covering the cathode half-cell and the lower side covering the anode half-cell, was constructed of transparent polycarbonate plastic material. Into each half-cell was placed a copper electrode and an aqueous solution of copper (II) sulfate. The cathode half-cell contained a 1.0 M aqueous solution of copper (II) sulfate; and the anode half-cell contained a 0.0001 M aqueous solution of copper (II) chloride dihydrate. The two half-cells were connected with a salt bridge, the salt bridge being a U-shaped glass tube filled with unwoven cotton which had previously been soaked in an aqueous sodium chloride solution for about twenty minutes.

The initial voltage of the concentration cells was 22 mV. After 48 hours in a dimly lit and cool basement room (20° C.), the voltage was measured at 20 mV.

The concentration cell was then placed in direct sunlight with the air temperature about 27° C. The voltage was then recorded at various times during the day:

| | Time: | | | | |
|---|---|---|---|---|---|
| | 11 A.M. | 12 P.M. | 5 P.M. | 7 P.M. | 9 P.M. |
| Voltage (mV): | 20 | 34 | 45 | 35 | 30 |

The same cell was then placed in a basement. The voltage recorded at 11 P.M. was 27 mV.

After two days in the basement, the cell was placed in direct sunlight. At 9 P.M. the voltage measured 25 mV.

While specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the above description has been made in an illustrative fashion, and not a restrictive one. Combinations of the above embodiments, and other embodiments not specifically described herein will be apparent to those of skill in the art upon reviewing the foregoing disclosure. The scope of the invention should properly be determined with reference to the appended claims, along with the full range of equivalents to which such claims are entitled.

We claim:

1. A concentration cell for producing electrical energy, comprising:
(a) a housing defining a cathode chamber and an anode chamber, the housing having a bottom wall, two opposing end walls, two opposing side walls, and a slanted lid portion whereby solvent from the chambers that condenses onto the lid drips down the lid into the anode chamber;
(b) an impermeable partition separating said cathode chamber from said anode chamber;
(c) a first metal electrode disposed in said cathode chamber;
(d) a second metal electrode disposed in said anode chamber, the first and second electrodes being made from the same type of metal;
(e) a first electrolyte solution having an initial concentration of cations of the same type of metal as said first electrode, the first electrolyte solution being disposed in said cathode chamber;
(f) a second electrolyte solution having an initial concentration of cations of the same type of metal as said second electrode, the second electrolyte solution being disposed in said anode chamber, the initial concentration of cations in said first electrolyte solution being greater than the initial concentration of cations in said second electrolyte solution, and
(g) an ion-exchange member disposed between said cathode chamber and said anode chamber, said member having two ends and wherein one end is submerged in the first electrolyte solution and the other end is submerged in the second electrolyte solution.

2. A concentration cell according to claim 1 wherein the slanted lid portion is constructed from a transparent material which is a member selected from the group consisting of glass, polycarbonate, and acrylic resin.

3. A concentration cell according to claim 1 wherein the ion-exchange member is a semipermeable membrane.

4. A concentration cell according to claim 1 wherein the ion-exchange member is a salt-bridge.

5. An ion-exchange member according to claim 4 wherein the salt bridge has a shape which is a member selected from the groups consisting of an inverted U-tube and a straight tube.

6. A concentration cell according to claim 1 further comprising a seal which is interposed between the lid and the top edges of the walls of the housing to ensure a watertight and airtight seal between the lid and the walls of the housing.

7. A concentration cell according to claim 1 wherein each electrode is a member selected from the group consisting of copper, silver, and nickel.

8. A concentration cell according to claim 1 wherein the walls of the cathode half-cell are colored black to maximize heat absorption from the sun.

9. A concentration cell according to claim 1 wherein the walls of the anode half-cell are covered by aluminum foil in order to reflect the sun.

10. A concentration cell according claim 1 wherein the walls of the anode half-cell are colored white in order to reflect the sun.

11. A concentration cell according to claim 1 wherein the lid portion extends downwardly from the cathode chamber to the anode chamber.

12. A concentration cell for producing electrical energy, comprising:
(a) a housing defining a cathode chamber and an anode chamber, the housing comprising concentric outer and inner cylinders mounted on a base, the outer cylinder having a diameter greater than the inner cylinder; the inner cylinder being the anode chamber and the outer cylinder being the cathode chamber;
(b) a circular lid having an inverted cone depending from the bottom surface of the lid;
(c) an inverted U-tube positioned over a wall of the inner cylinder;
(d) a first metal electrode disposed in said cathode chamber;
(e) a second metal electrode disposed in said anode chamber, the first and second electrodes being made from the same type of metal;
(f) a first electrolyte solution having an initial concentration of cations of the same type of metal as said first and second electrodes, the first electrolyte solution being disposed in said cathode chamber; and
(g) a second electrolyte solution having an initial concentration of cations of the same type of metal as said first and second electrode, the second electrolyte solution being disposed in said anode chamber, the initial concentration of cations in said first electrolyte solution being greater than the initial concentration of cations in said electrolyte solution.

14. A concentration cell according to claim 12 wherein the electrodes are in the shape of metal rods.

15. A concentration cell according to claim 12 wherein the electrodes are in the shape of circular plates.

16. In a concentration cell for producing electrical energy, the cell comprising a housing defining a cathode chamber and an anode chamber; an ion-exchange member disposed between the cathode chamber and the anode chamber; a first metal disposed in the cathode chamber; a second metal electrode disposed in the anode chamber, wherein the first and second electrodes are made from the same metal; a first electrolyte solution having an initial concentration of cations of the same metal as solid electrodes, the first electrolyte solution being disposed in the cathode chamber; and a second electrolyte solution having an initial concentration of cations of the same metal as said electrodes, the second electrolyte solution being disposed in the anode chamber, wherein the initial concentration of cations in the first electrolyte solution is greater than the initial concentration of cations in the second electrolyte solution; the improvement comprising a fully sealed covering over the top of the housing, wherein the covering has a geometric shape such that water which evaporates and then condenses on an inside surface of the covering will fall as by gravity substantially into the anode chamber.

17. A concentration cell according to claim 16 wherein the initial concentration of cations in the first electrolyte solution is greater than the initial concentration of cations in the second electrolyte solution by at least two orders of magnitude.
